(19) United States
(12) Patent Application Publication
(10) Pub. No.: US 2026/0152364 A1
(43) Pub. Date: Jun. 4, 2026

(54) METHODS, INTERNET OF THINGS LARGE MODEL SYSTEMS, AND STORAGE MEDIA FOR SMART CITY ELEVATOR OPERATION

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Guanghua HUANG, Chengdu (CN); Xing SHU, Chengdu (CN)

(73) Assignee: CHENGDU QINCHUAN IOT TECHNOLOGY CO., LTD., Chengdu (CN)

(21) Appl. No.: 19/457,123

(22) Filed: Jan. 22, 2026

(30) Foreign Application Priority Data
Oct. 20, 2025 (CN) 202511496703.2

(51) Int. Cl. B66B 1/28; B66B 5/02; G06V 20/52; G06V 40/16

(52) U.S. Cl. CPC B66B 1/28; B66B 5/027; G06V 20/52; G06V 40/174

(57) ABSTRACT

Disclosed are a method and an IoT large model system for smart city elevator operation, and a storage medium. The method includes: determining an anomaly feature of a target elevator based on a load and an elevator feature of the target elevator through an anomaly database corresponding to the target elevator; determining an elevator operation risk of the target elevator based on the anomaly feature; determining a passenger posture feature and a passenger distribution feature based on elevator car image data of the target elevator, and determining a passenger behavior risk; determining an out-of-control risk of the target elevator based on the elevator operation risk and the passenger behavior risk; generating an elevator regulation instruction for the target elevator based on the out-of-control risk; and controlling an operation speed of the target elevator based on the elevator regulation instruction.

### CROSS REFERENCE TO RELATED APPLICATIONS

This application claims priority to Chinese Patent Application No. 202511496703.2, filed on Oct. 20, 2025, the entire contents of which are incorporated herein by reference.

### TECHNICAL FIELD

The present disclosure generally relates to a field of urban elevator supervision, and in particular to a method for smart city elevator operation, an Internet of Things large model system for smart city elevator operation, and a storage medium.

### BACKGROUND

In urban life, elevators have become indispensable. However, due to issues such as an inadequate maintenance and an overloading operation, the elevators face abnormal operation risks including car falling and passenger entrapment. Currently, elevator safety assessment primarily relies on manual periodic inspections, but this manner requires substantial labor costs and may not achieve emergency risk management.

Therefore, to accurately identify or assess whether an out-of-control risk of the elevator (e.g., elevator out-of-control, passenger panic, etc.) exists, it is necessary to provide a method for smart city elevator operation, an Internet of things large model system for smart city elevator operation, and a storage medium, which accurately determine the out-of-control risk of the elevator in real time and perform emergency regulation in response to achieve effective emergency supervision.

### SUMMARY

One or more embodiments of the present disclosure provide a method for smart city elevator operation. The method for smart city elevator operation includes: in a first period, determining an anomaly feature of a target elevator based on a load and an elevator feature of the target elevator through an anomaly database corresponding to the target elevator; determining an elevator operation risk of the target elevator based on the anomaly feature; determining a passenger posture feature and a passenger distribution feature based on elevator car image data of the target elevator, and determining a passenger behavior risk; determining an out-of-control risk of the target elevator based on the elevator operation risk and the passenger behavior risk; generating an elevator regulation instruction for the target elevator based on the out-of-control risk; controlling an operation speed of the target elevator based on the elevator regulation instruction.

One or more embodiments of the present disclosure provide an Internet of things large model system for smart city elevator operation. The Internet of things large model system for smart city elevator operation includes an emergency supervision user platform, an emergency supervision service platform, an emergency supervision management platform, an emergency supervision sensor network platform, and an emergency supervision object platform. The emergency supervision management platform is configured to execute the method for smart city elevator operation.

One or more embodiments of the present disclosure provide a non-transitory computer-readable storage medium storing computer instructions, wherein when reading the computer instructions in the storage medium, a computer executes the method for smart city elevator operation.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same counting denotes the same structure, wherein:

FIG. 1 is a schematic diagram illustrating a platform structure of an Internet of Things large model system for smart city elevator operation according to some embodiments of the present disclosure;

FIG. 2 is a flowchart illustrating an exemplary process for smart city elevator operation according to some embodiments of the present disclosure;

FIG. 3 is a schematic diagram illustrating an exemplary process for generating a passenger-carrying response instruction according to some embodiments of the present disclosure; and

FIG. 4 is a schematic diagram illustrating an exemplary process for updating an elevator regulation instruction according to some embodiments of the present disclosure.

### DETAILED DESCRIPTION

Drawings used in the description of the embodiments are briefly introduced below. The drawings do not represent all embodiments.

The terms, including system, device, unit, module, etc., used in the present disclosure refer to a method for distinguishing components, elements, parts, portions, or assemblies at different levels. However, if other words can achieve the same purpose, the words may be replaced by other expressions.

Unless the context clearly indicates an exception, words such as a, an, one, and/or the, are not limited to the singular form and may include the plural form. Generally, the terms include and comprise only indicate the inclusion of explicitly identified operations and elements, and these operations and elements do not constitute an exclusive list. The method or device may also include other operations or elements.

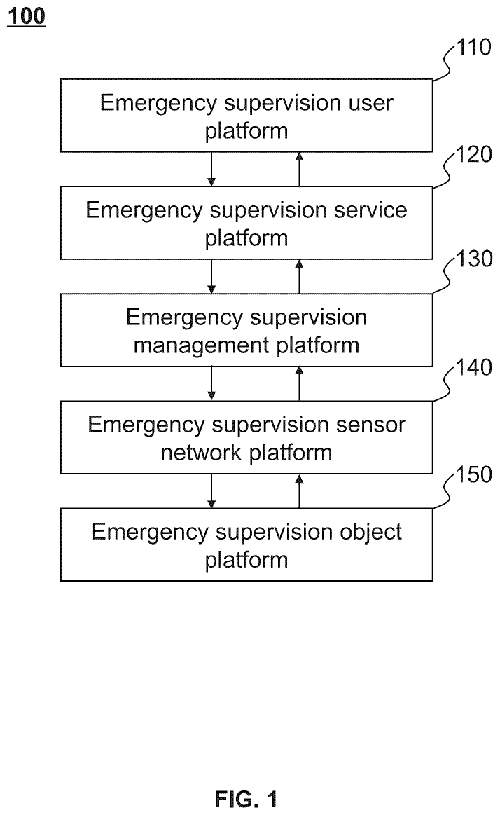

FIG. 1 is a schematic diagram illustrating a platform structure of an Internet of Things (IoT) large model system for smart city elevator operation according to some embodiments of the present disclosure.

In some embodiments, as shown in FIG. 1, the IoT large model system for smart city elevator operation 100 (hereinafter referred to as IoT large model system 100) includes an emergency supervision user platform 110, an emergency supervision service platform 120, an emergency supervision management platform 130, an emergency supervision sensor network platform 140, and an emergency supervision object platform 150.

The emergency supervision user platform 110 refers to a platform used by higher-level regulatory authorities to comprehensively coordinate emergency supervision, which includes a third-party terminal. For example, the emergency supervision user platform 110 may be a computer or other devices with input and/or output functions.

The emergency supervision service platform 120 refers to an interactive service platform for receiving and transmitting data, which includes a communication terminal. For example, the emergency supervision service platform 120 may be a wireless phone, a video monitor, a multimedia computer, etc.

In some embodiments, the emergency supervision service platform 120 interacts upward with the emergency supervision user platform 110 and interacts downward with the emergency supervision management platform 130.

The emergency supervision management platform 130 refers to a comprehensive platform for processing and managing emergency supervision data, which includes a processor, a storage device, etc. In some embodiments, the processor includes one or more sub-processing devices (e.g., a single-core processing device or a multi-core multi-chip processing device). Merely by way of example, the processor includes a central processing unit (CPU), an application-specific integrated circuit (ASIC), etc., or any combination thereof.

The storage device may be configured to store data and/or instructions. In some embodiments, the storage device includes a mass storage device, a removable storage device, etc., or any combination thereof. The storage device is implemented on a cloud platform.

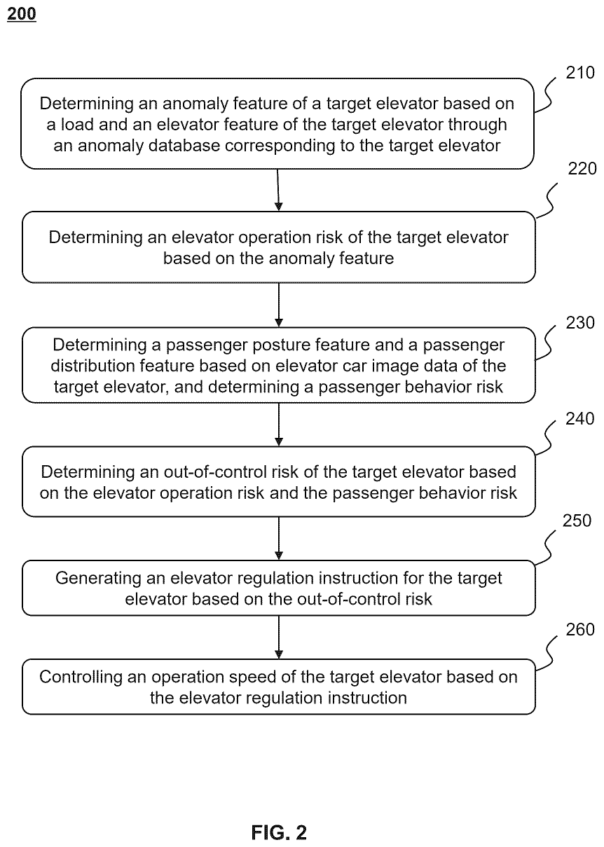

In some embodiments, the emergency supervision management platform 130 is configured to execute a method for smart city elevator operation. More content about the method may be found in the related descriptions of FIGS. 2-4.

The emergency supervision sensor network platform 140 refers to a management platform for transmitting emergency supervision-related sensor data or information, which includes a communication network or a gateway, a network interface, etc.

In some embodiments, the emergency supervision sensor network platform 140 interacts upward with the emergency supervision management platform 130 and interacts downward with the emergency supervision object platform 150.

The emergency supervision object platform 150 refers to a platform for collecting the emergency supervision data and implementing execution instructions, which includes a target elevator, and a microchip and a communication device in the target elevator.

The target elevator refers to an elevator that requires operation monitoring. In some embodiments, the target elevator is calibrated by an elevator operation supervisor.

The target elevator includes an elevator car for bearing weight, a guide rail for transporting the elevator car, and a traction machine for providing power for transportation. The target elevator is configured with a sensor, a monitoring device, etc.

The microchip may be configured for calculation, data processing, etc., e.g., a CPU, a microprogrammed control unit (MCU), an ASIC, etc. The communication device may be configured for data and signal transmission, etc., e.g., a Bluetooth module, a gateway, etc.

More contents about the above platforms may be found in FIGS. 2-4 and the related descriptions.

In some embodiments of the present disclosure, the IoT large model system for smart city elevator operation forms an information operation closed loop between various functional platforms, and operates in a coordinated and regular manner under the unified management of the emergency supervision management platform, so as to improve a processing efficiency for emergency scenarios by dynamically adjusting an elevator control instruction with high efficiency and precision

FIG. 2 is a flowchart illustrating an exemplary process for smart city elevator operation according to some embodiments of the present disclosure. As shown in FIG. 2, a process 200 includes the following operations. In some embodiments, the process 200 is executed by an emergency supervision management platform in an IoT large model system for smart city elevator operation (e.g., the emergency supervision management platform 130 in the IoT large model system 100).

A first period refers to a preset period for executing the method for smart city elevator operation. A duration of the first period may be predetermined manually, e.g., 10 minutes, 20 minutes, etc. In some embodiments, the processor executes the following operations 210-260 within the first period.

In 210, the processor determines an anomaly feature of a target elevator based on a load and an elevator feature of the target elevator through an anomaly database corresponding to the target elevator.

The load of the target elevator refers to a load of the target elevator at a current moment, which is obtained by monitoring through a weight sensor.

The elevator feature refers to a feature related to an operation condition of the elevator. For example, the elevator feature includes a mechanical feature, an operation parameter, and environmental data. The elevator feature of the target elevator may include elevator features at a plurality of time points in a current time period of the target elevator. The current time period refers to a time period adjacent to the current moment, e.g., 2 minutes before the current moment.

The mechanical feature may include a vibration amplitude of an elevator car, a vibration amplitude of a guide rail, etc., which is obtained by monitoring through vibration sensors disposed outside the elevator car and on the guide rail.

The operation parameter may include a speed of the elevator car, etc., which is obtained by monitoring through speed sensors installed at a shaft end of a traction machine and on a speed limiter shaft of the guide rail.

The environmental data may include a temperature and a humidity, etc., in a shaftway where the target elevator is located, which is obtained by monitoring through a temperature sensor and a humidity sensor disposed in the shaftway.

The anomaly database corresponding to the target elevator refers to a database storing the elevator feature when the target elevator is in an abnormal state, and each target elevator has its corresponding anomaly database. The abnormal state may be a failure of the target elevator. The abnormal state includes a plurality of anomaly types, e.g., rail slipping, wire rope slack, an elevator door failure, etc.

In some embodiments, the anomaly database includes a plurality of load ranges, and a plurality of abnormal elevator feature ranges respectively corresponding to the plurality of anomaly types under each load range. For example, Mᵢ-Lⱼ-(Qᵢⱼ, Dᵢⱼ, Vᵢⱼ, Wᵢⱼ, Sᵢⱼ) denotes that under a load range Mᵢ, an abnormal elevator feature range corresponding to an anomaly type Lⱼ includes an abnormal elevator car vibration amplitude range Qᵢⱼ, an abnormal guide rail vibration amplitude range Dᵢⱼ, an abnormal elevator car speed curve Vᵢⱼ, an abnormal temperature range Wᵢⱼ, and an abnormal humidity range Sᵢⱼ. Different values of i denote different load ranges, and different values of j denote different anomaly types. The abnormal elevator feature ranges corresponding to different combinations of i and j are different.

In some embodiments, the anomaly database is preset manually based on historical experience.

In some embodiments, the emergency supervision management platform determines a plurality of anomaly reference features of the target elevator under different load ranges based on historical anomaly data of the target elevator, and constructs the anomaly database corresponding to the target elevator based on the plurality of anomaly reference features.

In some embodiments, the load ranges are divided in a plurality of manners. For example, the emergency supervision management platform equally divides a rated load range of the target elevator into a preset count of load ranges. The preset count is preset manually based on actual situations.

In some embodiments, the emergency supervision management platform determines a division granularity of the load ranges based on a load distribution of the target elevator.

In some embodiments, the load distribution includes a plurality of candidate load ranges and a duration proportion of the load of the target elevator in each candidate load range. In some embodiments, the candidate load ranges are preset manually. The plurality of candidate load ranges have no intersection with each other, and a union of the plurality of candidate load ranges covers the rated load range of the target elevator. The duration proportion of the load of the target elevator in a candidate load range refers to a ratio of an operation duration of the target elevator in the candidate load range to a total operation duration. The load distribution may be obtained based on historical data statistics.

The division granularity refers to a granularity for dividing the candidate load ranges. The load ranges may be determined by re-dividing the candidate load ranges according to the division granularity.

In some embodiments, a candidate load range with a greater duration proportion in the load distribution has a greater division granularity. For example, a candidate load range of 150-180 KG has a duration proportion of 30% and a division granularity of 3, i.e., the candidate load range is divided into three load ranges: 150-160 KG, 160-170 KG, and 170-180 KG. A candidate load range of 100-150 KG has a duration proportion of 10% and a division granularity of 1, i.e., no further division is required.

In some embodiments of the present disclosure, determining the division granularity of the load ranges based on the load distribution is beneficial for improving a coverage rate of data in the anomaly database for daily operation situations of the target elevator; and is also beneficial for improving an accuracy of elevator operation risk assessment in a load range with a greater duration proportion.

The historical anomaly data refers to elevator operation data of the target elevator when an anomaly occurs during a historical operation process. The elevator operation data includes the load, the elevator feature, and the anomaly type described above. The historical anomaly data includes a historical load and a historical elevator feature when a historical anomaly occurred, and a corresponding historical anomaly type. In some embodiments, the historical anomaly data is obtained based on historical records.

In some embodiments, the anomaly database includes a plurality of anomaly reference combinations. Each anomaly reference combination includes one load range and one anomaly reference feature corresponding to one anomaly type feature under the load range. The anomaly reference feature refers to a feature characterizing an abnormal state of the target elevator. In some embodiments, one anomaly reference feature includes an abnormal elevator car vibration amplitude range, an abnormal guide rail vibration amplitude range, an abnormal elevator car speed curve, an abnormal temperature range, and an abnormal humidity range.

For example, the above (Mᵢ-Lⱼ-(Qᵢⱼ, Dᵢⱼ, Vᵢⱼ, Wᵢⱼ, Sᵢⱼ) represents the anomaly reference combination, and (Qᵢⱼ, Dᵢⱼ, Vᵢⱼ, Wᵢⱼ, Sᵢⱼ) represents the anomaly reference feature. The plurality of anomaly reference features corresponding to the plurality of anomaly types under different load ranges constitute a plurality of anomaly reference combinations. The anomaly database is constructed based on the plurality of anomaly reference combinations.

In some embodiments, the emergency supervision management platform obtains the historical anomaly data of the target elevator in the plurality of load ranges. For each load range, the emergency supervision management platform counts a historical elevator feature range when each anomaly type occurs within the load range, and determines the anomaly reference feature corresponding to each anomaly type.

In some embodiments, the emergency supervision management platform obtains the plurality of anomaly reference features corresponding to the plurality of anomaly types under different load ranges, constructs the plurality of anomaly reference combinations, and constructs the anomaly database based on the plurality of anomaly reference combinations.

In some embodiments of the present disclosure, by obtaining the anomaly reference features and then constructing the anomaly database, failure situations of the target elevator are specifically summarized, which facilitates a rapid determination of an anomaly feature. By considering connections between the plurality of anomaly reference features, a subsequent analysis of an elevator risk situation is made more consistent with actual situations.

The anomaly feature refers to a feature in the elevator feature that is abnormal, e.g., an abnormal elevator car vibration amplitude, an abnormal guide rail vibration amplitude, an abnormal elevator car speed, an abnormal temperature, an abnormal humidity, etc.

In some embodiments, the emergency supervision management platform determines a current feature range sequence based on the elevator feature of the target elevator. The current feature range sequence refers to a sequence composed of a current elevator car vibration amplitude range, a current guide rail vibration amplitude range, a current elevator car speed curve, a current temperature range, and a current humidity range; determines a load range where the load of the target elevator is located in the anomaly database corresponding to the target elevator, determines a plurality of anomaly reference combinations corresponding to the load range in the anomaly database; compares the current feature range sequence with a plurality of anomaly reference features corresponding to the plurality of anomaly reference combinations, determines an anomaly reference feature that has a data overlap with the current feature range sequence, and determines a specific elevator feature that has the data overlap as the anomaly feature.

In some embodiments, the anomaly feature further includes an overlap degree corresponding to the anomaly feature. The overlap degree is represented by a ratio of a data overlap range to the abnormal elevator feature range.

For example, the load range where the load of the target elevator is located is M₁. There are three anomaly reference combinations corresponding to the load range M₁ in the anomaly database. The current feature range sequence is (Q*, D*, V*, W*, S*). There are two anomaly reference features that have the data overlap with the current feature range sequence: (Q₁₁, D₁₁, V₁₁, W₁₁, S₁₁) and (Q₁₂, D₁₂, V₁₂, W₁₂, S₁₂). Specifically, Q* overlaps with Q₁₁ and Q₁₂, V* overlaps with V₁₁, and W* overlaps with W₁₁ and W₁₂. Then the anomaly feature includes an abnormal elevator car vibration amplitude Q, an abnormal elevator car speed V, and an abnormal temperature W. An overlap degree co corresponding to the anomaly feature Q is a sum of a range ratio of Q* to Q₁₁ and a range ratio of Q* to Q₁₂. An overlap degree C._{W} corresponding to the anomaly feature W is determined similarly. An overlap degree C._{V} corresponding to the anomaly feature V is a range ratio of V* to V₁₁. Exemplarily, Q* is (0.3 m/s², 0.4 m/s²), Q₁₁ is (0.2 m/s², 0.5 m/s²), and Q₁₂ is (0.3 m/s², 0.7 m/s²), then

$${C}_{Q} = ( \frac{0.1}{0.3} + \frac{0.1}{0.4} ) / 2.$$

In 220, the processor determines an elevator operation risk of the target elevator based on the anomaly feature.

The elevator operation risk refers to a risk of the target elevator being out of control due to the operation failure of the target elevator. In some embodiments, the elevator operation risk is represented by a numerical value. A higher numerical value indicates a greater elevator operation risk.

In some embodiments, the processor determines the elevator operation risk of the target elevator based on the anomaly feature. For example, for each anomaly feature, the processor performs a normalization processing on the overlap degree corresponding to the anomaly feature and an importance degree of the anomaly feature, performs a first weighted summation on a result of the normalization processing, and determines a first weighted summation result corresponding to the anomaly feature. The processor further performs a second weighted summation on first weighted summation results corresponding to the plurality of anomaly features, and determines a second weighted summation result as the elevator operation risk. The importance degree of each anomaly feature may be determined based on manual preset. A manner for the normalization processing may include linear function normalization (Min-Max Scaling), etc.

In some embodiments, weights of the overlap degree and the importance degree in the first weighted summation are determined based on manual preset. Weights corresponding to the plurality of anomaly features in the second weighted summation are determined based on the historical anomaly data. For example, the processor calculates a frequency of occurrence of each anomaly feature in the historical anomaly data. A higher frequency indicates a greater weight corresponding to the anomaly feature in the second weighted summation.

In 230, the processor determines a passenger posture feature and a passenger distribution feature based on elevator car image data of the target elevator, and determines a passenger behavior risk.

The elevator car image data refers to image data inside the elevator car at a plurality of time points within a current time period. In some embodiments, the elevator car image data is obtained by a monitoring device disposed inside the elevator car.

The passenger posture feature refers to a feature related to a posture of a passenger, including a static action and a dynamic action of the passenger. The static action may include leaning against a wall, standing upright, etc. The dynamic action may include jumping, running, etc.

The passenger distribution feature refers to a position distribution feature of a plurality of passengers inside the elevator car, e.g., position coordinates of the plurality of passengers, etc.

In some embodiments, the passenger posture feature and the passenger distribution feature are obtained by the processor based on the elevator car image data through an image recognition model. The image recognition model may be a convolutional neural network, etc.

The passenger behavior risk refers to a risk that the target elevator is out of control due to a passenger behavior. In some embodiments, the passenger behavior risk is represented by a value. The higher the value, the greater the passenger behavior risk.

In some embodiments, the processor determines the passenger behavior risk based on the passenger posture feature and the passenger distribution feature. Merely by way of example, the processor performs a clustering analysis on the passenger posture feature and the passenger distribution feature to determine the passenger behavior risk. Objects to be clustered include a target vector and a plurality of cluster vectors. The target vector is constructed based on the passenger posture feature and the passenger distribution feature. Each cluster vector is constructed based on a historical passenger posture feature and a historical passenger distribution feature in a historical period of the target elevator. A label of the cluster vector indicates whether the target elevator is out of control in the historical period corresponding to the cluster vector. The label may be manually annotated. If the target elevator is out of control, the label is recorded as 1. If the target elevator is not out of control, the label is recorded as 0. The processor may cluster the target vector and the plurality of cluster vectors to obtain a plurality of clusters. The cluster containing the target vector is taken as a target cluster. A proportion of cluster vectors with the label of 1 in the target cluster is calculated. The proportion is taken as the passenger behavior risk.

In 240, the processor determines an out-of-control risk of the target elevator based on the elevator operation risk and the passenger behavior risk.

The out-of-control risk of the target elevator refers to an overall assessed risk that the target elevator is out of control. In some embodiments, the out-of-control risk of the target elevator is represented by a value. The higher the value, the greater the risk that the target elevator is out of control.

In some embodiments, the processor determines the out-of-control risk of the target elevator based on the elevator operation risk and the passenger behavior risk through a plurality of manner. For example, the processor performs the normalization processing on the elevator operation risk and the passenger behavior risk, performs a third weighted summation on a result of the normalization processing, and determines a third weighted summation result as the out-of-control risk. Weights of the elevator operation risk and the passenger behavior risk in the third weighted summation may be manually preset based on experience.

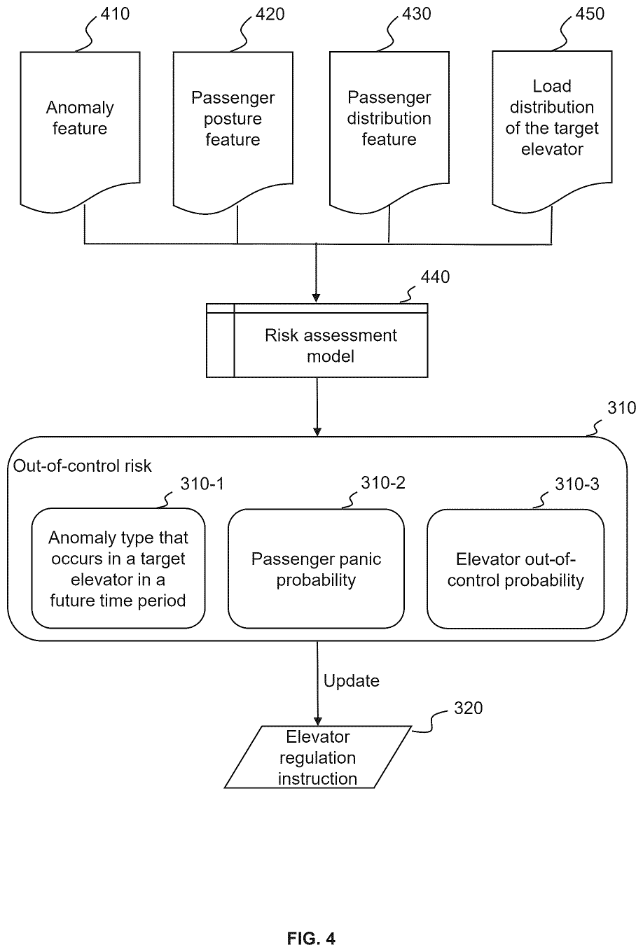

In some embodiments, the processor further determines the out-of-control risk of the target elevator based on the anomaly feature, the passenger posture feature, and the passenger distribution feature through a risk assessment model. More contents about this part may be found in FIG. 4 and the descriptions thereof.

In 250, the processor generates an elevator regulation instruction for the target elevator based on the out-of-control risk.

The elevator regulation instruction refers to an instruction for regulating an operation of the target elevator. In some embodiments, the elevator regulation instruction includes a speed reduction amplitude.

The speed reduction amplitude refers to an amplitude for reducing an operation speed of the target elevator. For example, the speed reduction amplitude is 20%, i.e., reducing a current operation speed of the target elevator by 20%.

In some embodiments, for each target elevator, the processor determines the elevator regulation instruction based on the out-of-control risk through a plurality of manners. For example, the processor determines the elevator regulation instruction based on the out-of-control risk through a first preset table. The first preset table includes a correspondence between the out-of-control risk and the speed reduction amplitude. The first preset table may be determined based on manual preset.

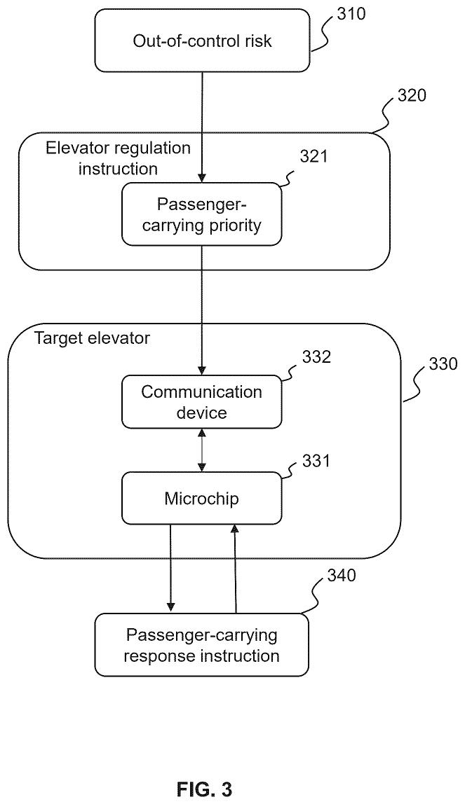

In some embodiments, the elevator regulation instruction further includes a passenger-carrying priority. In some embodiments, the processor determines the passenger-carrying priority of the target elevator based on the out-of-control risk. More contents about this part may be found in the relevant descriptions of FIG. 3.

In 260, the processor controls the operation speed of the target elevator based on the elevator regulation instruction.

In some embodiments, the processor controls the operation speed of the target elevator based on the elevator regulation instruction. For example, the processor adjusts the operation speed of the target elevator based on the speed reduction amplitude. As another example, the processor controls the target elevator to run to a passenger floor to stop based on a passenger-carrying response instruction.

In some embodiments of the present disclosure, by calculating the elevator operation risk and the passenger behavior risk in the first period, the out-of-control risk of the target elevator is determined. A mechanical failure of the target elevator itself and the passenger behavior are taken into consideration, which can improve the accuracy and reasonability of determining the out-of-control risk of the target elevator, thereby determining an elevator regulation instruction suitable for an actual situation, and achieving a precise control of the operation speed of the target elevator.

FIG. 3 is a schematic diagram illustrating an exemplary process for generating a passenger-carrying response instruction according to some embodiments of the present disclosure.

In some embodiments, as shown in FIG. 3, a microchip 331 and a communication device 332 are further integrated in a target elevator 330. For more content about the microchip the communication device, refer to the relevant description of FIG. 1.

As shown in FIG. 3, an elevator regulation instruction 320 includes a passenger-carrying priority 321. The emergency supervision management platform may determine the passenger-carrying priority 321 of the target elevator based on an out-of-control risk 310; and send the passenger-carrying priority 321 to the target elevator 330. The target elevator 330 generates a passenger-carrying response instruction 340.

The passenger-carrying priority refers to a priority at which the target elevator responds to passenger boarding service requests.

In some embodiments, the processor determines the passenger-carrying priority of the target elevator based on the out-of-control risk through a plurality of manners. For example, the processor performs an ascending sort on out-of-control risks of a plurality of target elevators belonging to a same elevator group; and determines the passenger-carrying priority of each target elevator based on a ranking obtained from the ascending sort. A higher ranking indicates a lower out-of-control risk and a higher passenger-carrying priority. The same elevator group refers to a set of elevators located in a same elevator room and having a same function.

In some embodiments, the passenger-carrying response instruction is configured to control the target elevator to run to a passenger floor to stop.

In some embodiments, the processor sends the passenger-carrying priority to the target elevator. The target elevator generates the passenger-carrying response instruction. For example, the microchip in each target elevator obtains the passenger priorities of other target elevators in the same elevator group through the communication device. When a passenger presses a button, the microchip of the target elevator detects whether there is another target elevator with a higher passenger-carrying priority in the same elevator group that is in an unloaded state, or in a state of not being fully loaded and heading to the passenger floor. If there exists another target elevator with the higher passenger-carrying priority in the same elevator group that is in the unloaded state, or in the state of not being fully loaded and heading to the passenger floor, the target elevator does not generate the passenger-carrying response instruction. If no other target elevator with the higher passenger-carrying priority in the same elevator group is in the unloaded state, or in the state of not being fully loaded and heading to the passenger floor, the target elevator automatically generates the passenger-carrying response instruction.

In some embodiments of the present disclosure, by setting a lower passenger-carrying priority for the elevator with a higher out-of-control risk, a probability of passengers being trapped is reduced by preventing the elevator with a greater failure risk from frequently carrying passengers.

FIG. 4 is a schematic diagram illustrating an exemplary process for updating an elevator regulation instruction according to some embodiments of the present disclosure.

In some embodiments, as shown in FIG. 4, the out-of-control risk 310 further includes an anomaly type that occurs in a target elevator in a future time period 310-1, a passenger panic probability 310-2 corresponding to an anomaly type, and an elevator out-of-control probability 310-3 corresponding to the anomaly type.

In some embodiments, as shown in FIG. 4, the processor determines the out-of-control risk 310 based on an anomaly feature 410, a passenger posture feature 420, and a passenger distribution feature 430 through a risk assessment model 440. The risk assessment model 440 is a machine learning model. The processor further updates the elevator regulation instruction 320 based on the out-of-control risk 310, and controls an operation speed of the target elevator based on an updated elevator regulation instruction.

The future time period refers to a time period after a current moment. A duration of the future time period may be set by the processor by default or preset manually. In some embodiments, the duration of the future time period is greater than a duration of a first period, or less than the duration of the first period. Merely by way of example, the duration of the future time period is 1.5 times the duration of the first period. As another example, the duration of the future time period is 0.5 times the duration of the first period.

The passenger panic probability refers to a probability that a passenger panics when an anomaly occurs in the target elevator.

The elevator out-of-control probability refers to a probability that the target elevator becomes out of control when the anomaly occurs.

The risk assessment model is a model configured to determine the out-of-control risk. In some embodiments, the risk assessment model is a machine learning model, e.g., a deep neural network (DNN) model, etc.

As shown in FIG. 4, inputs of the risk assessment model 440 include the anomaly feature 410, the passenger posture feature 420, and the passenger distribution feature 430. Outputs of the risk assessment model include the anomaly type that occurs in the target elevator in the future time period 310-1, the passenger panic probability 310-2 corresponding to the anomaly type, and the elevator out-of-control probability 310-3 corresponding to the anomaly type.

More details about the anomaly feature, the anomaly type, the passenger posture feature, and the passenger distribution feature may be found in FIG. 2 and the related descriptions.

In some embodiments, the emergency supervision management platform trains the risk assessment model based on a plurality of first training samples with first labels. The emergency supervision management platform may input the first training samples into an initial risk assessment model, construct a loss function based on the first labels, output results of the initial risk assessment model, iteratively update parameters of the initial risk assessment model based on a loss function, and obtain a trained risk assessment model after an iteration end condition is satisfied. A manner for iterative update includes, but is not limited to, gradient descent. The iteration end condition may be a convergence of the loss function or a count of iterations reaching a threshold.

The first training samples are obtained based on historical data. The first training samples include a historical anomaly feature, a historical passenger posture feature, and a historical passenger distribution feature corresponding to the target elevator in a historical first time period.

The first labels include an anomaly type that occurred in a historical second time period under a historical situation corresponding to the first training samples of the target elevator, an actual passenger panic probability corresponding to the anomaly type, and an actual elevator out-of-control probability corresponding to the anomaly type. For one anomaly type, the actual passenger panic probability corresponding to the anomaly type is represented by a ratio of a count of occurrences where the anomaly type caused the passenger to panic to a total count of occurrences of the anomaly type in the historical second time period. The actual elevator out-of-control probability corresponding to the anomaly type is represented by a ratio of a count of occurrences where the anomaly type caused the elevator to become out of control to the total count of occurrences of the anomaly type. The historical second time period is after the historical first time period, i.e., the historical second time period is a future time period of the historical first time period.

In some embodiments, as shown in FIG. 4, the inputs of the risk assessment model further include a load distribution of the target elevator 450.

Contents of the load distribution may be found in related descriptions in FIG. 2.

In some embodiments, the risk assessment model is trained based on a great number of second training samples with second labels. The second training samples may include the first training samples and a historical load distribution of the target elevator in the historical first time period. The second labels include the anomaly type that occurred in the historical second time period under a historical situation corresponding to the second training samples of the target elevator, the actual passenger panic probability corresponding to the anomaly type, and the actual elevator out-of-control probability corresponding to the anomaly type. An obtaining process of the second labels may refer to the obtaining process of the first labels described above.

In some embodiments of the present disclosure, the load distribution of the target elevator reflects a wear degree of hardware devices in the elevator. Inputting the load distribution of the target elevator into the risk assessment model improves an accuracy of the output of the risk assessment model.

In some embodiments, the processor updates the elevator regulation instruction based on the out-of-control risk. For example, the processor determines the passenger panic probabilities corresponding to each anomaly type included in the out-of-control risk and a probability mean of the passenger panic probabilities. If probability means corresponding to a plurality of anomaly types are all greater than a first risk threshold, a speed reduction amplitude included in the elevator regulation instruction is increased, i.e., the operation speed of the target elevator is further reduced. An increase amount of the speed reduction amplitude may be preset manually.

In some embodiments, the first risk threshold is negatively correlated to a count of passengers in the target elevator.

In some embodiments of the present disclosure, determining the out-of-control risk by the risk assessment model based on the anomaly feature, the passenger posture feature, and the passenger distribution feature enables an advanced prediction and a graded regulation of the out-of-control risk of the elevator. Merely by way of example, when the count of passengers in the target elevator is great, a loss caused by the elevator being out of control is greater. In this case, the first risk threshold needs to be appropriately reduced to ensure a regulation sensitivity of the elevator speed, thereby ensuring passenger safety.

In some embodiments, in response to the passenger panic probability satisfying a preset condition, the processor obtains passenger expression data from image data collected by a monitoring device, updates the elevator regulation instruction based on the passenger expression data, and controls the operation speed of the target elevator based on the updated elevator regulation instruction.

The preset condition refers to a condition of the passenger panic probability required to trigger the collection of the passenger expression data. Merely by way of example, the preset condition is that a mean of a plurality of passenger panic probabilities corresponding to the plurality of anomaly types is greater than a second risk threshold.

In some embodiments, the second risk threshold is greater than the first risk threshold. The second risk threshold is positively correlated to a passenger dispersion degree.

The passenger dispersion degree refers to a degree of dispersion of the passengers in an elevator car. The passenger dispersion degree may be determined based on the passenger distribution feature. A smaller sum of distances between position coordinates of the plurality of passengers indicates a smaller passenger dispersion degree.

The smaller passenger dispersion degree indicates that when a panic behavior occurs for one passenger, an impact on other passengers is greater. Therefore, the second risk threshold needs to be appropriately reduced at this time to identify facial expressions of the passengers at a higher frequency and perform a regulation, thereby avoiding the passengers from losing control.

The passenger expression data refers to facial expression of the passenger, which includes relaxed, focused, leisurely, anxious, tense, panicked, etc.

In some embodiments, the processor processes the image data collected by the monitoring device through a facial expression recognition model to obtain the passenger expression data of each passenger. The facial expression recognition model may be a deep learning network, etc.

In some embodiments, the processor adjusts the elevator regulation instruction based on the passenger expression data. Merely by way of example, if a proportion of passengers in a non-relaxed state is higher than a preset proportion threshold, the speed reduction amplitude included in the elevator regulation instruction is increased, and the elevator regulation instruction further includes a stop instruction for controlling the target elevator to stop at a nearest floor.

The non-relaxed state refers to a facial expression being in a negative state such as tense, uneasy, or panicked. The preset proportion threshold may be set manually based on experience.

In some embodiments of the present disclosure, dynamically adjusting the operation speed of the elevator by analyzing the passenger expression data (e.g., panic, anxiety) in real time avoids a spread of panic emotions, or avoids an occurrence of out-of-control behavior caused by group panic, which leads to the elevator being out of control, thereby improving the elevator safety and riding experience in emergency situations.

In some embodiments, at intervals of a second period, the processor performs incremental training on the risk assessment model based on elevator operation data of a previous second period. A duration of the second period is greater than a duration of the first period.

The second period refers to a time interval at which the incremental training of the model is performed for updating.

In some embodiments, the duration of the second period is greater than the duration of the first period. The duration of the second period may be set based on experience, e.g., one week, etc.

The elevator operation data includes a plurality of anomaly features of the target elevator, and the passenger posture feature and the passenger distribution feature corresponding to the anomaly features.

In some embodiments, the processor continues to train the risk assessment model based on an existed risk assessment model using newly added elevator operation data of the previous second period.

For example, the processor continues to train the risk assessment model based on third training samples and third labels. The third training samples include a historical anomaly feature, a historical passenger posture feature, and a historical passenger distribution feature corresponding to the target elevator in a historical third time period. The third labels include an anomaly type that occurred in a historical fourth time period under a historical situation corresponding to the third training samples of the target elevator, an actual passenger panic probability corresponding to the anomaly type, and an actual elevator out-of-control probability corresponding to the anomaly type. The historical third time period and the historical fourth time period belong to the previous second period, and the third time period is before the historical fourth time period. The obtaining process of the third labels may refer to the obtaining process of the first labels described above.

In some embodiments of the present disclosure, performing the incremental training on the pre-trained model based on the data of each target elevator improves the pertinence of the model to the corresponding target elevator, thereby improving the accuracy of the model output.

Some features, structures, or characteristics in one or more embodiments of the present disclosure may be appropriately combined.

In addition, unless explicitly stated in the claims, the order of processing elements and sequences, the use of numbers and letters, or the use of other names in the present disclosure are not intended to limit the order of the processes and methods of the present disclosure. Although the present disclosure discusses some inventive embodiments currently considered useful through various examples, it should be understood that such details are for illustrative purposes only, and the appended claims are not limited to the disclosed embodiments. Instead, the claims are intended to cover all modifications and equivalent combinations that conform to the substance and scope of the embodiments of the present disclosure. For example, although the implementation of various components described above may be embodied in a hardware device, it may also be implemented as a software only solution, e.g., an installation on an existing server or mobile device.

If the description, definition, and/or use of terms in the materials cited by the present disclosure are inconsistent or conflict with the content described in the present disclosure, the description, definition, and/or use of terms in the present disclosure shall prevail.

What is claimed is:

1. An Internet of things (IoT) large model system for smart city elevator operation, comprising: an emergency supervision user platform, an emergency supervision service platform, an emergency supervision management platform, an emergency supervision sensor network platform, and an emergency supervision object platform;
wherein the emergency supervision management platform is configured to:
within a first period,
determine an anomaly feature of a target elevator based on a load and an elevator feature of the target elevator through an anomaly database corresponding to the target elevator;
determine an elevator operation risk of the target elevator based on the anomaly feature;
determine a passenger posture feature and a passenger distribution feature based on elevator car image data of the target elevator, and determine a passenger behavior risk;
determine an out-of-control risk of the target elevator based on the elevator operation risk and the passenger behavior risk;
generate an elevator regulation instruction for the target elevator based on the out-of-control risk; and
control an operation speed of the target elevator based on the elevator regulation instruction.

2. The IoT large model system of claim 1, wherein the target elevator is integrated with a microchip and a communication device, the elevator regulation instruction includes a passenger-carrying priority, and the emergency supervision management platform is further configured to:
determine the passenger-carrying priority of the target elevator based on the out-of-control risk; and
send the passenger-carrying priority to the target elevator, the target elevator generating a passenger-carrying response instruction, wherein the passenger-carrying response instruction is configured to control the target elevator to stop at a passenger floor.

3. The IoT large model system of claim 1, wherein the emergency supervision management platform is further configured to:
determine a plurality of anomaly reference features of the target elevator under different load ranges based on historical anomaly data of the target elevator; and
construct the anomaly database corresponding to the target elevator based on the plurality of anomaly reference features.

4. The IoT large model system of claim 3, wherein the emergency supervision management platform is further configured to:
determine a division granularity of the different load ranges based on a load distribution of the target elevator.

5. The IoT large model system of claim 1, wherein the out-of-control risk further includes an anomaly type that is likely to occur in the target elevator within a future time period, a passenger panic probability corresponding to the anomaly type, and an elevator out-of-control probability, and the emergency supervision management platform is further configured to:
determine the out-of-control risk based on the anomaly feature, the passenger posture feature, and the passenger distribution feature through a risk assessment model, wherein the risk assessment model is a machine learning model; and
update the elevator regulation instruction based on the out-of-control risk, and control the operation speed of the target elevator based on an updated elevator regulation instruction.

6. The IoT large model system of claim 5, wherein an input of the risk assessment model includes a load distribution of the target elevator.

7. The IoT large model system of claim 5, wherein the emergency supervision management platform is further configured to:
in response to that the passenger panic probability satisfies a preset condition, obtain passenger expression data from image data collected by a monitoring device; and
update the elevator regulation instruction based on the passenger expression data, and control the operation speed of the target elevator based on an updated elevator regulation instruction.

8. The IoT large model system of claim 5, wherein the emergency supervision management platform is further configured to:
at intervals of a second period, perform incremental training on the risk assessment model based on elevator operation data of a previous second period, wherein a duration of the second period is greater than a duration of the first period.

9. A method for smart city elevator operation, wherein the method is executed by an emergency supervision management platform in an Internet of things (IoT) large model system for smart city elevator operation within a first period, and the method comprises:
determining an anomaly feature of a target elevator based on a load and an elevator feature of the target elevator through an anomaly database corresponding to the target elevator;
determining an elevator operation risk of the target elevator based on the anomaly feature;
determining a passenger posture feature and a passenger distribution feature based on elevator car image data of the target elevator, and determining a passenger behavior risk;
determining an out-of-control risk of the target elevator based on the elevator operation risk and the passenger behavior risk;
generating an elevator regulation instruction for the target elevator based on the out-of-control risk; and
controlling an operation speed of the target elevator based on the elevator regulation instruction.

10. The method of claim 9, wherein the target elevator is integrated with a microchip and a communication device, the elevator regulation instruction includes a passenger-carrying priority, and the method further comprises:
determining the passenger-carrying priority of the target elevator based on the out-of-control risk; and
sending the passenger-carrying priority to the target elevator, the target elevator generating a passenger-carrying response instruction, wherein the passenger-carrying response instruction is configured to control the target elevator to stop at a passenger floor.

11. The method of claim 9, wherein the method further comprises:
determining a plurality of anomaly reference features of the target elevator under different load ranges based on historical anomaly data of the target elevator; and
constructing the anomaly database corresponding to the target elevator based on the plurality of anomaly reference features.

12. The method of claim 11, wherein the method further comprises:
determining a division granularity of the different load ranges based on a load distribution of the target elevator.

13. The method of claim 9, wherein the out-of-control risk further includes an anomaly type that is likely to occur in the target elevator within a future time period, a passenger panic probability corresponding to the anomaly type, and an elevator out-of-control probability, and the method further comprises:
determining the out-of-control risk based on the anomaly feature, the passenger posture feature, and the passenger distribution feature through a risk assessment model, wherein the risk assessment model is a machine learning model; and
updating the elevator regulation instruction based on the out-of-control risk, and controlling the operation speed of the target elevator based on an updated elevator regulation instruction.

14. The method of claim 13, wherein an input of the risk assessment model includes a load distribution of the target elevator.

15. The method of claim 13, wherein the method further comprises:
in response to that the passenger panic probability satisfies a preset condition, obtaining passenger expression data from image data collected by a monitoring device; and
updating the elevator regulation instruction based on the passenger expression data, and controlling the operation speed of the target elevator based on an updated elevator regulation instruction.

16. The method of claim 13, wherein the method further comprises:
at intervals of a second period, performing incremental training on the risk assessment model based on elevator operation data of a previous second period, wherein a duration of the second period is greater than a duration of the first period.

17. A non-transitory computer-readable storage medium storing computer instructions, wherein when reading the computer instructions in the storage medium, a computer executes the method for smart city elevator operation of claim 9.
